(19) United States
(12) Patent Application Publication
(10) Pub. No.: US 2015/0059233 A1
(43) Pub. Date: Mar. 5, 2015

(54) FISH GRIP

(71) Applicant: FRANK WILLIAM HAGUE, Cape Coral, FL (US)

(72) Inventor: FRANK WILLIAM HAGUE, Cape Coral, FL (US)

(21) Appl. No.: 14/471,059

(22) Filed: Aug. 28, 2014

Related U.S. Application Data
(60) Provisional application No. 61/872,702, filed on Aug. 31, 2013.

(51) Int. Cl. A01K 97/00

(52) U.S. Cl. CPC A01K 97/00
USPC 43/54.1

(57) ABSTRACT

A fish grip includes a backing layer having a top surface and a bottom surface; a plurality of bristles, fixed to said backing layer, and extending from the top surface; and a base handle attached to the bottom surface. The fish grip can be bent along an axis that defines a first grip portion having a first bristle set and a second grip portion having a second bristle set facing the first bristle set, with the first and second grip portions defining a pocket therebetween. The first and second sets can simultaneously abut the fish to frictionally hold the fish in the static position.

### RELATED DOCUMENTS

This document is related to, claims the priority benefit of, and incorporated by reference in its entirety, U.S. Provisional Patent Application Ser. No. 61/872,702, entitled “Fish Grip,” and filed on Aug. 31, 2013 by Frank William Hague.

### FIELD OF THE INVENTION

The present invention relates to commercial and recreational fishing, and more specifically, to the handling of fish.

### BACKGROUND OF THE INVENTION

Fish gripping mechanisms can be used to hold fish. Such mechanisms can allow the physical manipulation of fish, including handling, fishing hook and lure removal, movement, and positional maintenance of fish, whilst securely holding such fish.

### SUMMARY OF THE INVENTION

It is, therefore, an object of the present invention to provide a fish grip.

It is another object of the present invention to provide a fish grip that can facilitate user manipulation of a fish, including holding, moving, and releasing, of the fish.

An exemplary environment of the present invention can include a user and a fish. Further, an exemplary environment can include recreational and commercial environments.

The present invention can be embodied in a fish grip having a backing layer with top and bottom surfaces; a plurality of bristles, fixed to the backing layer, and extending from the top surface; and a base handle attached to the bottom surface.

In an exemplary aspect of the present invention, such a fish grip can be bent along an axis that defines a first grip portion having a first bristle set and a second grip portion having a second bristle set facing the first bristle set, such that the first and second grip portions define a pocket between the first and second grip portions.

In another exemplary aspect of the present invention, the first and second bristle sets can simultaneously abut the fish to frictionally hold the fish in the static position.

In a further exemplary aspect of the present invention, each of a majority of the bristles can be spaced at most a particular distance from another bristle, such as one inch, a half of an inch, etc., for example and not in limitation.

In another exemplary embodiment of the present invention, a grip can further include an auxiliary handle having first and second auxiliary handle ends respectively attached to the bottom surface.

In still another exemplary embodiment of the present invention, a grip can further include a safety layer, formed of a puncture-resistant material, and disposed between one or more handles and the bristles.

The following optional exemplary aspects can be applied to any embodiment of the present invention: a handle can include first and second handle ends respectively attached to the bottom surface; a handle can form a loop; each handle end of a handle can be attached to one of the first and second grip portions; and the axis can bisect one of a length and a width of the fish grip.

### BRIEF DESCRIPTION OF THE DRAWINGS

FIG. 1 illustrates a basic embodiment of the present invention in which a fish grip can include a backing layer, a plurality of bristles, and at least one handle.

FIG. 2 illustrates a top-view of a fish grip and an exemplary engagement protocol with a user's hand.

FIG. 3 illustrates a user utilizing an exemplary fish grip to hold a fish with one hand.

FIG. 4 illustrates an exemplary grip having an optional safety layer.

### DETAILED DESCRIPTION

It is an object of the present invention to provide a fish grip to allow a user to physically manipulate a fish, such a fish grip having a plurality of embodiments, which are described, and are to be broadly interpreted, via the disclosure herein.

It should be noted that this disclosure includes a plurality of elements and/or aspects, and such elements and/or aspects need not necessarily be interpreted as being conjunctively required by one or more embodiments of the present invention. Rather, all combinations of the one or more elements and/or aspects can enable a separate embodiment of the present invention, which may be claimed with particularity in one or more future filed Non-Provisional Patent Applications. Moreover, any particular materials, structures, and/or sizes disclosed herein, whether expressly or implicity, are to be construed strictly as illustrative and enabling, and not necessarily limiting. Therefore, it is expressly set forth that such materials, structures, and/or sizes independently or in any combination of one of more thereof, are merely illustratively representative of one or more embodiments of the present invention and are not to be construed as necessary in a strict sense.

Further, to the extent the same element or limitation is defined differently anywhere within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

The present invention provides a fish grip, which can be used to conveniently hold a live fish. Via such a fish gripper, a user can grasp a live fish with one hand, and release the same without releasing the gripper.

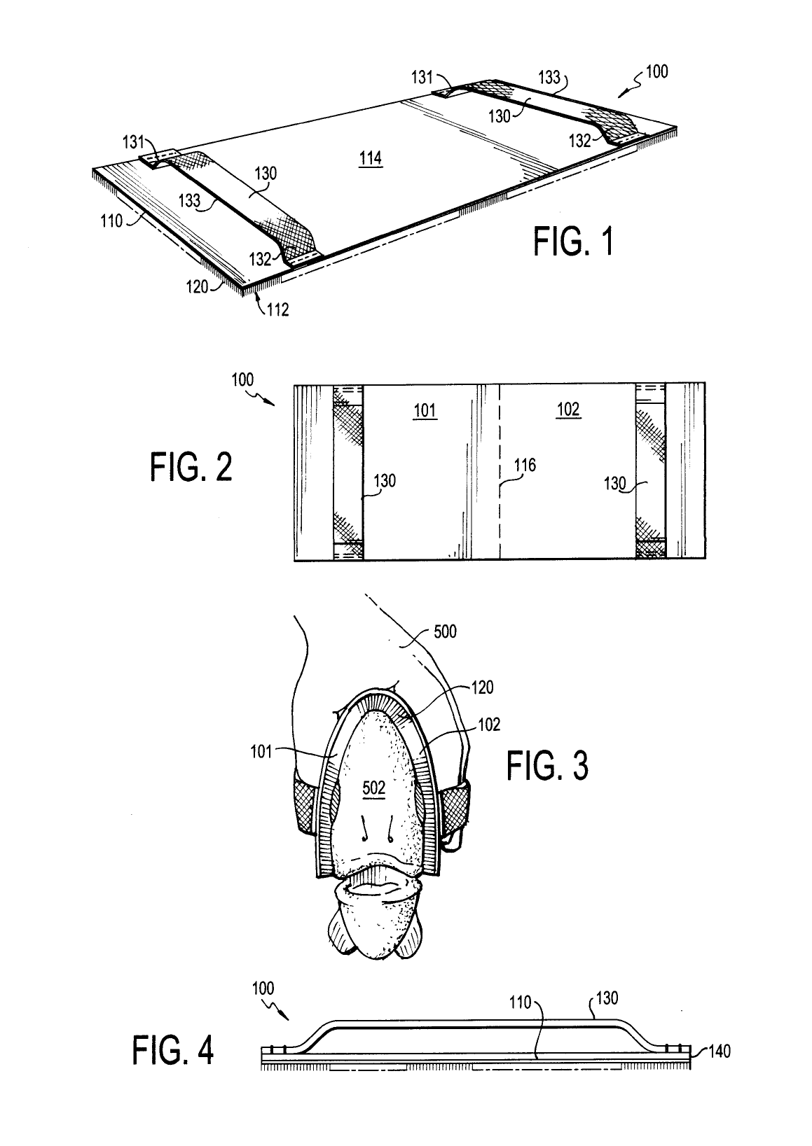

FIG. 1 illustrates an exemplary embodiment of the present invention, in which an exemplary fish gripper 100 for holding a fish (502 in FIG. 3) can include a backing layer 110 having a top surface 112 and a bottom surface 114; a plurality of bristles 120 fixed to the backing layer and extending from the top surface; and at least one handle 130 attached to the bottom surface.

In an exemplary aspect of the present invention, backing layer 110 can be provided in any desired size or shape that is functionally consistent with the present invention. For example and not in limitation, backing layer 110 can be provided in a 9 inch by 5 inch configuration; however, as noted above, backing layer 110 can be provided in any geometric shape or shapes, insofar as the same is functionally compatible with the present invention. Further, backing layer 110 can be formed from any one or more desired materials, which are functionally consistent with the present invention; such as, for example and not in limitation, a synthetic material, such as latex, rubber, polyester, polypropylene, and/or any other man-made or naturally occurring material or materials, such as jute.

In another exemplary aspect of the present invention, bristles 120 can be provided in any desired size, density, or shape that is functionally consistent with the present invention. For example and not in limitation, bristles 120 can be spaced at about 0.25 inches apart, and can have varying shapes, and further, can have a length of about 0.25 inches. Notably, any alternative spacing and/or length of bristles 120 are deemed to be functionally compatible with the present invention, and therefore, are intended equivalents. As another example, and not in limitation, bristles 120 can be formed from any one or more materials that are functionally consistent with the present invention. For example, and not in limitation, bristles 120 can be formed from one or more synthetic materials, such as latex, rubber, nylon, olefin, polypropylene, polyethylene, acrylic, DURACORD®, or any other man-made or naturally occurring material or materials. Further, such material can be inherently, or configured to be, at least partially flexible, for example and not in limitation.

In a further exemplary aspect of the present invention, as noted above, bristles 120 can be fixed to backing layer 110. According to the present invention, such fixing can be effectuated in any manner that is functionally compatible with the present invention, such as via an adhesive, weaving, or molded therein or therewith.

In another exemplary aspect of the present invention, fish grip 100 can include at least one handle 130. Handle 130 can be formed of any desired material that is functionally consistent with the present invention, such as a plastic, fabric, or metal, for example and not in limitation. In a further exemplary aspect, handle 130 can be fixed to backing layer 110 in any manner functionally consistent with the present invention, such as via an adhesive, a rivet, a staple, or alternatively, handle 130 can be integral with backing layer 110, such as via molding or weaving. Further, handle 130 can optionally be configured so that at least a portion thereof is biased upwardly via material selection (such as an at least partially rigid material), modification (such as heating, forming, and/or cooling), and/or reinforcement with another material (including stitching or otherwise combining). As illustrated in FIG. 1, in one exemplary embodiment, handle 130 can optionally be configured to have first and second raised portions 131, 132, and an elevated portion 133. And as illustrated in FIG. 3, such a configuration can allow a user to engage fish grip 100 with one hand by slidably inserting their index, middle, and ring, and pinky fingers under the elevated portion 133. Optionally, with the provisioning of a second handle 130, a user can also slidably insert their thumb under the elevated portion 133 of the second handle; yet without such second handle, the user can nonetheless manipulate the fish grip 100 as disclosed with their thumb against backing layer 110 to facilitate the bending of grip 100 (as further described infra). Notably, a handle 130 can also be provided in alternative configurations, such as, for example and not in limitation, a pocket, or a pair of tabs each having an elevated portion, for example and not in limitation, with any such configuration optionally having an elevated portion to allow engagement of grip 100 by a user with one hand.

As further illustrated in FIG. 2, fish grip 100 can be bendable along a line 116, so as to form a first grip portion 101 and a second grip portion 102. In an exemplary aspect of the present invention, when a user so engages fish grip 100 via handle 130, the fish grip can bend along line 116 in cooperation with a natural gripping motion of the user's hand as exemplarily disclosed herein.

Accordingly, as illustrated in FIG. 3, with a fish grip engaged with a user's hand 500, the user can position first and second grip portions 101,102 against opposite sides of a fish 502, with respective bristles 120 facing opposite sides of the fish, such that the bristles can provide sufficient friction to securely grip the fish for manipulation thereof by the user.

When such manipulation is completed, a user can then position the fish above a target area (such as a bucket, a body of water, etc.), and naturally open their hand to move first and second grip portions 101,102 away from the fish, which then allows the fish to fall to the target area whilst the at least one handle 130 maintains engagement with the user's hand 500.

As illustrated in FIG. 4, fish grip 100 can optionally include a safety layer 140, which can be provided between handle(s) 130 and backing layer 110. Safety layer 140 can be provided via any one or more materials that are puncture resistant; and may further optionally, be sufficiently flexible so as to compatibly fold with backing layer 110 along line 116. For example and not in limitation, safety layer can be formed from any one or more of the following materials: metal, plastic, rubber, a woven material, a solid material, rubber, nitrile rubber, CORDURA®, etc., for example and not in limitation. Alternatively, safety layer 140 can be provided via a more rigid material, but in two pieces, with each piece respectively disposed to positionally correspond with first and second grip portions 101,102, such that the grip portions can be defined at, and bend along, line 116.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents of the appended claims.

Therefore, I claim:

1. In a fish-handling environment including a user and a fish, a fish grip for holding, by the user, the fish in a static position, said fish grip comprising:
a backing layer having a top surface and a bottom surface;
a plurality of bristles, fixed to said backing layer, and extending at least a particular distance from the top surface; and
a base handle attached to the bottom surface;
wherein said fish grip is bent along an axis that defines a first grip portion having a first bristle set and a second grip portion having a second bristle set facing the first bristle set, the first and second grip portions defining a pocket between the first and second grip portions, and the first and second bristle sets simultaneously abut the fish to frictionally hold the fish in the static position.

2. The grip of claim 1, wherein each of a majority of said bristles are spaced at most one inch from another bristle.

3. The grip of claim 1, wherein each of a majority of said bristles are spaced at most one half of an inch from another bristle.

4. The grip of claim 1, wherein said base handle includes first and second base handle ends respectively attached to the bottom surface.

5. The grip of claim 4, wherein said base handle forms a loop.

6. The grip of claim 4, wherein each of the first and second base handle ends are both attached to one of the first and second grip portions.

7. The grip of claim 6, further comprising an auxiliary handle having first and second auxiliary handle ends respectively attached to the bottom surface.

8. The grip of claim 7, wherein each of the first and second auxiliary handle ends are both attached to the other of the first and second grip portions.

9. The grip of claim 1, further comprising a safety layer, formed of a puncture-resistant material, and disposed between said base handle and said bristles.

10. The grip of claim 9, wherein said base handle includes first and second base handle ends respectively attached to the bottom surface.

11. The grip of claim 9, wherein said base handle forms a loop.

12. The grip of claim 9, wherein each of the first and second base handle ends are both attached to one of the first and second grip portions.

13. The grip of claim 12, further comprising an auxiliary handle having first and second auxiliary handle ends respectively attached to the bottom surface.

14. The grip of claim 13, wherein each of the first and second auxiliary handle ends are both attached to the other of the first and second grip portions.

15. The grip of claim 1, wherein the axis bisects one of a length and a width of the fish grip.

16. The grip of claim 15, further comprising a safety layer, formed of a puncture-resistant material, and disposed between said base handle and said bristles.

17. The grip of claim 16, wherein said base handle includes first and second base handle ends respectively attached to the bottom surface.

18. The grip of claim 16, wherein said base handle forms a loop.

19. The grip of claim 16, wherein each of the first and second base handle ends are both attached to one of the first and second grip portions.

20. The grip of claim 19, further comprising an auxiliary handle having first and second auxiliary handle ends respectively attached to the bottom surface.
